(19) United States
(12) Patent Application Publication
(10) Pub. No.: US 2015/0046307 A1
(43) Pub. Date: Feb. 12, 2015

(54) ITEM LEVEL PERSONAL FINANCE MANAGEMENT (PFM) FOR DISCRETIONARY AND NON-DISCRETIONARY SPENDING

(71) Applicant: Bank of America Corporation, Charlotte, NC (US)

(72) Inventors: Matthew A. Calman, Charlotte, NC (US); Jason P. Blackhurst, Charlotte, NC (US); Katherine Dintenfass, Charlotte, NC (US); Laura C. Bondesen, Charlotte, NC (US); Carrie Anne Hanson, Charlotte, NC (US)

(73) Assignee: Bank of America Corporation, Charlotte, NC (US)

(21) Appl. No.: 13/961,584

(22) Filed: Aug. 7, 2013

(51) Int. Cl. G06Q 40/00

(52) U.S. Cl. CPC G06Q 40/00
USPC 705/35

(57) ABSTRACT

Embodiments of the invention are directed to apparatus, methods, and computer program products for providing automatic determination of discretionary and non-discretionary spending at a transaction item-level and providing related item-level filtering within a personal financial management application, such as online banking, mobile banking or the like. Such item-level filtering provides the customer with the detail necessary to ascertain the discretionary spend versus non-discretionary spend impact of items on an overall customer budget and to make necessary changes in future purchases so as to positively impact the customer's budget constraints.

### FIELD

In general, embodiments of the invention relate to methods, systems, apparatus and computer program products for personal finance management and, more particularly, for automated item-level determination of discretionary and non-discretionary spending within a personal finance management application provided by a financial institution.

### BACKGROUND

There has been recent growth in online banking, mobile banking and the like, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided by the merchant to the financial institution is information about the merchant and an overall transaction amount. For example, if a financial institution customer purchases several clothing items from a merchant and uses a financial institution debit card, credit card or check, all that is provided to the financial institution is the merchant information and overall purchase amount. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall, what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Therefore, a need exists to improve online/mobile banking and the like and, in particular budgetary features related to online/mobile banking and the like. In particular a need exists to automatically incorporate item-level detail into the budgetary features of online/mobile banking

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for automated item-level determination of discretionary and non-discretionary spending within a personal finance management application provided by a financial institution, such as online banking, mobile banking or the like.

An apparatus for determining discretionary and non-discretionary spending and providing related filtering within a personal financial management application defines first embodiments of the invention. The apparatus includes a computing platform having a memory and at least one processor in communication with the memory device. An aggregation and structuring application is stored in the memory, executable by the processor and configured to receive transaction item-identifying data in an unstructured format, structure the transaction item-identifying data for financial institution system accessibility and store the structured data in a first database. The transaction item-identifying data is associated with a transaction conducted by a customer. The apparatus further includes an item determination application stored in the memory, executable by the processor and configured to determine, from the structured transaction item-identifying data, an identification of one or more items in the transaction.

In addition the apparatus includes a discretionary and non-discretionary spend determination application stored in the memory, executable by the processor and configured to (i) determine a spend category for the one or more items in the transaction based on the identification of the items and predetermined spend categories and (ii) determine whether each of the one or more items is a discretionary spend or a non-discretionary spend based on predetermined discretionary and non-discretionary designations of the predetermined spend categories. The apparatus further includes a personal finance management application, stored in the memory, executable by the processor and configured to provide discretionary spend and non-discretionary spend filtering for items within transactions, wherein the filtering is configured to provide views of which items, and a corresponding purchase amount, are categorized as discretionary spending and non-discretionary spending.

In alternate embodiments of the apparatus, the aggregation and structuring application is further configured to receive an e-receipt corresponding to the transaction conducted by the identified customer. The e-receipt includes one or more unique identifiers (e.g., a Stock Keeping Unit (SKU) or the like) each of which identify the one or more items in the transaction. In further related embodiments of the apparatus, the aggregation and structuring application is further configured to crawl an email account held by the identified customer to identify and collect e-receipts received by the identified customer.

In further alternate embodiments the apparatus includes a discretionary spend tracking application stored in the memory, executable by the processor and configured to, in response to determining that an item is a discretionary spend, apply the purchase amount of the discretionary spend to a predetermined discretionary spend allowance. In such embodiments of the apparatus, the discretionary spend tracking application is further configured to generate and initiate communication of an alert that is configured to notify the customer that they are approaching or have exceeded the predetermined discretionary spend allowance.

In further alternate embodiments the apparatus includes a non-discretionary spend tracking application stored in the memory, executable by the processor and configured to, in response to determining that an item is a non-discretionary spend, apply the purchase amount of the non-discretionary spend to a related category tracking amount. In further related embodiments of the apparatus, the personal finance management application may be further configured to provide one or more non-discretionary spend tracking views that provide for tracking amounts spent within a non-discretionary spend category. In such embodiments of the apparatus, the personal finance management application may be further configured to provide the one or more non-discretionary spend tracking views that provide for comparing the tracked amounts spent within the non-discretionary spend category for a current period of time to, at least one of, (i) an amount spent by the customer within the non-discretionary spend category for a previous same period of time or (ii) an average amount spent by a group of demographically-similar other customers during the current period of time or the previous period of time.

In still further alternate embodiments the apparatus includes an offer determination application stored in the memory, executable by the processor and configured to determine one or more offers to provide to the customer related to one or more items in a non-discretionary spend category, wherein the offers determined are based on a total amount spent within the non-discretionary spend category over a predetermined period of time.

A method for determining discretionary and non-discretionary spending and providing related filtering within a personal financial management application defines second embodiments of the invention. The method includes receiving, by a computing device processor, transaction item-identifying data in an unstructured format. The transaction item-identifying data is associated with a transaction conducted by a customer. The method further includes structuring, by a computing device processor, the transaction item-identifying data for financial institution system accessibility. The structuring may include parsing the data using predetermined templates and formatting the data to accommodate financial institution accessibility.

The method further includes determining, by a computing device processor, from the structured transaction item-identifying data, an identification (e.g., a Stock Keeping Unit (SKU) or the like) of one or more items in the transaction. In addition, the method includes determining, by a computing device processor, a spend category for the one or more items in the transaction based on the identification and predetermined spend categories and determining, by a computing device processor, whether each of the one or more items is a discretionary spend or a non-discretionary spend based on predetermined discretionary and non-discretionary designations of the predetermined spend categories.

Further the method includes providing, by a computing device processor, within a network-accessible personal finance management application, discretionary spend and non-discretionary spend filtering for items within transactions, wherein the filtering is configured to provide views of which items and a corresponding purchase amount are categorized as discretionary spending and non-discretionary spending.

In alternate embodiments of the method, receiving the transaction item-identifying data further includes receiving an e-receipt corresponding to the transaction conducted by the identified customer. The e-receipt includes one or more unique identifiers each of which identify the one or more items in the transaction. In such embodiments the method may further include crawling, by a computing device processor, an email account held by the identified customer to identify and collect e-receipts received by the identified customer.

In other alternate embodiments the method includes, in response to determining that an item is a discretionary spend, applying, by a computing device processor, the purchase amount of the discretionary spend to a predetermined discretionary spend allowance. In such embodiments the method may further include generating and initiating communication, by a computing device processor, of an alert that notifies the customer that they are approaching or have exceeded the predetermined discretionary spend allowance.

In still further alternate embodiments the method includes, in response to determining that an item is a non-discretionary spend, applying, by a computing device processor, the purchase amount of the non-discretionary spend to a related category tracking amount. In such embodiments the method may additionally include providing, by a computing device processor, within the network-accessible personal finance management application, one or more non-discretionary spend tracking views that provide for tracking amounts spent within a non-discretionary spend category. The spend tracking views may be configured to provide for comparing the tracked amounts spent within the non-discretionary spend category for a current period of time to, at least one of, an amount spent by the customer within the non-discretionary spend category for a previous same period of time or an average amount spent by a group of demographically-similar other customers during the current period of time or the previous period of time.

In still further embodiments the method may include determining, by a computing device processor, one or more offers to provide to the customer related to one or more items in a non-discretionary spend category, wherein the offers determined are based on a total amount spent within the non-discretionary spend category over a predetermined period of time.

A computer program product including a non-transitory computer-readable medium defines third embodiments of the invention. The computer-readable medium includes a first set of codes for causing a computer to receive, receiving transaction item-identifying data in an unstructured format. The transaction item-identifying data is associated with a transaction conducted by a customer. In addition, the computer-readable medium includes a second set of codes for causing a computer to structure the transaction item-identifying data for financial institution system accessibility.

In addition, the computer-readable medium includes a third set of codes for causing a computer to determine from the structured transaction item-identifying data, an identification of one or more items in the transaction. Additionally, the computer-readable medium includes a fourth set of codes for causing a computer to determine a spend category for the one or more items in the transaction based on the identification and predetermined spend categories and a fifth set of codes for causing a computer to determine whether each of the one or more items is a discretionary spend or a non-discretionary spend based on predetermined discretionary and non-discretionary designations of the predetermined spend categories.

Moreover, the computer-readable medium includes a sixth set of codes for causing a computer to provide, within a network-accessible personal finance management application, discretionary spend and non-discretionary spend filtering for items within transactions, wherein the filtering is configured to provide views of which items and a corresponding purchase amount are categorized as discretionary spending and non-discretionary spending.

Thus, embodiments of the present invention, which are described in more detail below, provide for automatically determining discretionary and non-discretionary spending at a transaction item-level and providing related item-level filtering within a personal financial management application, such as online banking, mobile banking or the like. Such item-level filtering provides the customer with the detail necessary to ascertain the discretionary spend versus non-discretionary spend impact of items on an overall customer budget and to make necessary changes in future purchases so as to positively impact the customer's budget constraints.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a schematic diagram representation of an operating environment for retrieval of electronic communications relating to customer purchase transactions, parsing of data within such electronic communications into structured data, formatting the data for financial institution accessibility and inclusion of such data into a network-accessible financial institution application, in accordance with embodiments of the present invention;

FIG. 2 is a block diagram of an apparatus for determining discretionary and non-discretionary spend for items identified in a transaction and providing related filtering within a personal financial management application, in accordance with embodiments of the present invention;

FIG. 3 is a more detailed block diagram of an apparatus for determining discretionary and non-discretionary spend for items identified in a transaction and providing related filtering within a personal financial management application, in accordance with embodiments of the present invention;

FIG. 4 is a flow diagram of a method for determining discretionary and non-discretionary spend for items identified in a transaction and providing related filtering within a personal financial management application, in accordance with embodiments of the present invention; and

FIG. 5 is a schematic diagram of an operating environment for determining discretionary and non-discretionary spend for items identified in a transaction and providing related filtering within a personal financial management application, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “product” or “account” as used herein may include any financial product, service, or the like that may be provided to a customer from an entity that subsequently requires payment. A product may include an account, credit, loans, purchases, agreements, or the like between an entity and a customer. The term “relationship” as used herein may refer to any products, communications, correspondences, information, or the like associated with a customer that may be obtained by an entity while working with a customer. Customer relationship data may include, but is not limited to addresses associated with a customer, customer contact information, customer associate information, customer products, customer products in arrears, or other information associated with the customer's one or more accounts, loans, products, purchases, agreements, or contracts that a customer may have with the entity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that utilized accounts in arrears recovery.

Thus, embodiments of the present invention provide for automatically determining discretionary and non-discretionary spending at a transaction item-level and providing related item-level filtering within a personal financial management application, such as online banking, mobile banking or the like. Such item-level filtering provides the customer with the detail necessary to ascertain the discretionary spend versus non-discretionary spend impact of items on an overall customer budget and to make necessary changes in future purchases so as to positively impact the customer's budget constraints.

In the past few years, there has been an increase in the amount of electronic information provided by merchants to customers regarding purchase of products and services. In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is otherwise referred to as an electronic receipt, commonly referred to as an e-receipt, for the online purchase. The order confirmation includes detailed information regarding the products or services purchased. For example, in the case of a product, the order confirmation may include stock keeping unit “SKU” code level data, as well as other parameters, such as an order number, an order date, a product description, a product name, a product quantity, a product price, a product image, a product image or a hyperlink to the product image on a merchant website, the sales tax incurred, the shipping cost incurred, an order total, a billing address, a third party shipping company, a shipping address, an estimated shipping date, an estimated delivery date, a shipment tracking number, and the like. The order confirmation also includes information about the merchant, such as the name of the merchant, the address of the merchant, a telephone number of the merchant, a web address, and the like. For most online transactions, the merchant will send at least one second communication confirming shipment of the order. The order shipment confirmation is typically also sent via email to the customer and typically includes the same information as the order confirmation, and in addition, a shipping date, a shipment tracking number, and other relevant information regarding the order and shipment parameters.

Many merchants now also provide the option for customers to receive e-receipts when shopping at “brick and mortar” locations (i.e., physical locations). In general, at the point of sale, the customer may have previously configured or may be asked at the time of sale as to whether he or she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer, which are accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at “brick and mortar” locations and then store these transactions in the customer's online account.

For the most part, order confirmations, shipping confirmations, e-receipts, and other electronic communications between merchants and customers are used only by the customer as proof-of-purchase and for monitoring receipt of purchased items (i.e., for archival purposes). However, there is significant data that can be gleaned from this electronic information for the benefit of the customer, so that the customer may have detailed information regarding purchase history, spending, and the like.

Another development in the past few years has been the growth of online banking, mobile banking and the like, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided by the merchant to the financial institution is information about the merchant and an overall transaction amount. For example, if a financial institution customer purchases several clothing items from a merchant and uses a financial institution debit card, credit card or a check, all that is provided to the financial institution is the merchant information and overall purchase amount. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall, what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budgetary tools. In general, budgetary tools divide expenses into various categories, such as food, clothing, housing, transportation, and the like. It is typically advantageous to provide such budget tools with online banking information to populate these various categories with spend information. However, this is difficult where specifics regarding a purchase made by the merchant (such as SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate, if the customer is not using the receipt in making such allocations or the customer fails to recall exactly what items were purchased in previous transactions.

Traditional cash purchases are also problematic for integration of customer purchase transactions into online banking. In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying the customer of spending or budgeting regarding the fuel purchase.

As described above, currently financial institutions are not provided with detailed transaction level information regarding a purchase transaction by a customer from a merchant beyond merchant information and overall transaction price for inclusion in online banking. While detailed data (such as SKU level data) is provided to the customer via receipts, such information is not provided by the merchant to the financial institution. The information is available to the customer but not integratable into a customer's online banking for efficient and increased beneficial use of the information. Currently, a customer must retain her receipts and manually compare such receipts with online purchase transaction data and manually input related data into online banking to obtain an understanding of the details of a given purchase transaction.

In light of the above, the current invention contemplates use of purchase confirmation or e-receipt data and other electronic communication data between a merchant and customer regarding a transaction (referred to herein as transaction item-identifying data) in order to augment purchase transaction data in online banking, mobile banking and the like. The general concept is to retrieve such electronic communications from the customer, parse the data in these electronic communications, and associate the data from the electronic communications with the corresponding online purchase transaction data.

An initial barrier to integration of electronic communication data received by a customer from a merchant regarding a purchase transaction for inclusion into online banking is data format. Online banking data is in a structured form. Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

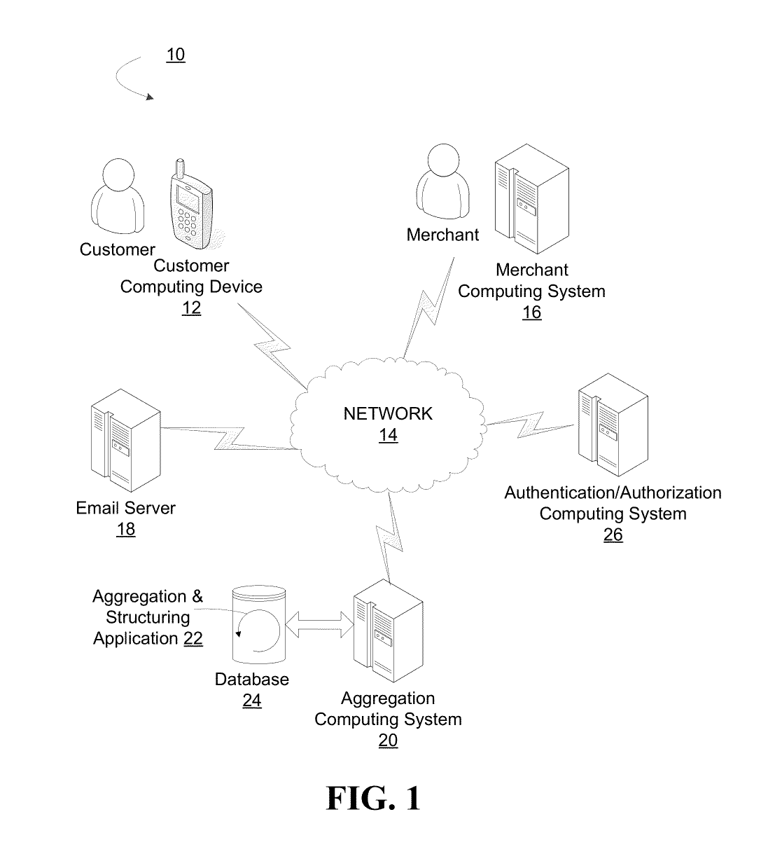

FIG. 1 is a diagram of an operating environment 10 according to one embodiment of the present invention for retrieval of electronic communications relating to customer purchase transactions, parsing of data within such electronic communications into structured data, formatting the data for financial institution accessibility and inclusion of such data into a network-accessible banking application, such as online or mobile banking. As illustrated a consumer maintains one or more computing devices 12, such as a PC, laptop, mobile phone, tablet, television, or the like that is network accessible for communicating across a network 14, such as the Internet, wide area network, local area network, short range/near field network, or any other form of contact or contactless network. Also, in the operating environment, is one or more merchant computing systems 16 that is network accessible. In the context of an online shopping experience, the merchant computing system 16 may be one or more financial transaction servers that, either individually or working in concert, are capable of providing web pages to a customer via the network 14, receiving purchase orders for items selected by the customer, communicating with the customer and third party financial institutions to secure payment for the order, and transmitting order confirmation, and possibly shipping confirmation information, to the customer via the network 14 regarding the purchase transaction. In the context of an in-store purchase, the merchant computing system 16 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information (e.g., e-receipt) to the customer related to the purchase transaction. If the customer has an online account with the merchant, the merchant computing system may also log the transaction information into the customer's online account.

In general, the merchant computing system will provide the customer with information relating to the purchase transaction. In the context of an online purchase, the communications may take the form of purchase order confirmations provided as a web page or as an email or as both. In some, embodiments, the merchant computing system may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data, as well as other parameters associated with the product, such as type/category, size, color, and the like, as well purchase price information, information associated with the merchant, and the like. The merchant computing system may also send other subsequent communications, such as communications confirming shipment of the order, which typically includes the same information as the purchase order confirmation, and in addition, shipping date, tracking number, and other relevant information regarding the order. In the context of an in-store purchase, the merchant computing system may send an e-receipt comprising information similar to that of the purchase order confirmation. In some instances, the customer may actually receive a paper receipt, which the customer may choose to scan into an electronic form and save in a storage device associated with the customer computing device 12. In the description herein, the term e-receipt may be used generically to refer to any communication or document provided by a merchant to a customer relating to a purchase transaction.

For a plurality of different purchase transactions, a customer may include purchase transaction item-identifying data (e.g., order confirmations, shipping confirmations, e-receipts, scanned receipts, typed or handwritten notes, invoices, bills of sale, and the like) in various locations and in various forms. The transaction item-identifying data could be stored in a storage device associated with the customer computing device 12, or in an email server 18, or in a customer's account at the merchant's computing system 16. Furthermore, as mentioned, the transaction item-identifying data is in an unstructured format. Each merchant may use a customized reporting format for the communications, whereby various data relating to the purchase transaction may be placed in different sequences, different locations, different formats, etc. for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, the operating environment further comprises an aggregation computing system 20 including aggregation and structuring application 22 stored in database 24. The aggregation computing system 20 is operatively connected to at least one of the customer computing device 12, the merchant computing system 16, and the email server 18 via the network 14. The aggregation and structuring application 22 is configured to initially crawl (i.e., search and locate) electronic communications associated with purchase transactions made by the customer, in for example, the customer's email, computer storage device, online accounts, and the like. For this purpose, the system may optionally include an authentication/authorization computing system 26 that comprises security IDs and passwords and other security information associated with the customer for accessing customer's email, storage devices, and customer online accounts.

Regarding email extraction, aggregation and structuring application 22 initially gains access to the customer's email accounts and retrieves email message headers comprising data fields relative to the email message, such as sender, subject, date/time sent, recipient, and the like. In some embodiments, the aggregation computing system accesses the emails directly. In other embodiments, the aggregation computing system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text included in email message bodies is unstructured (as opposed to the structured tagged elements in a hypertext markup language (HTML) web page, which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation and structuring application 22. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: i) a text order confirmation template; ii) an HTML order confirmation template; iii) a text shipping confirmation template; and iv) an HTML shipping confirmation template. In instances in which the email is an e-receipt from a “brick and mortar” purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, or e-receipt data. As mentioned, a customer may scan and save paper receipts, typed or printed notes, invoices, bills of sale, and the like in a storage device or print and save purchase order and shipping confirmation communications sent to the customer by the merchant via a web page. In this instance, the aggregation and structuring application 22 may first perform optical character recognition “OCR” on the scanned or printed receipts prior to perform the processing performed above. Further, a customer may maintain an online account with a merchant containing purchase data information. In this instance, the aggregation computing system 20 will access the data online via communication with merchant computing system to retrieve this data. The aggregation computing system 20 may use column and/or row headers associated with the online data to parse the data, or it may use procedures similar to the above and discussed below to parse the data into appropriate fields.

Returning to data processing procedures, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant)(Details about order)(Details about item 1)(Details about item 2) . . . (Details about item N)(Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 20 to parse the email message bodies, e-receipt bodies, online data, etc. to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Once the data has been properly parsed, the data may be required to be formatted to conform to financial institution specifications. For example, as previously noted, the data may be formatted to conform to Open Financial Exchange “OFX” specifications for the electronic exchange of financial data between financial institutions, businesses and customers via the Internet.

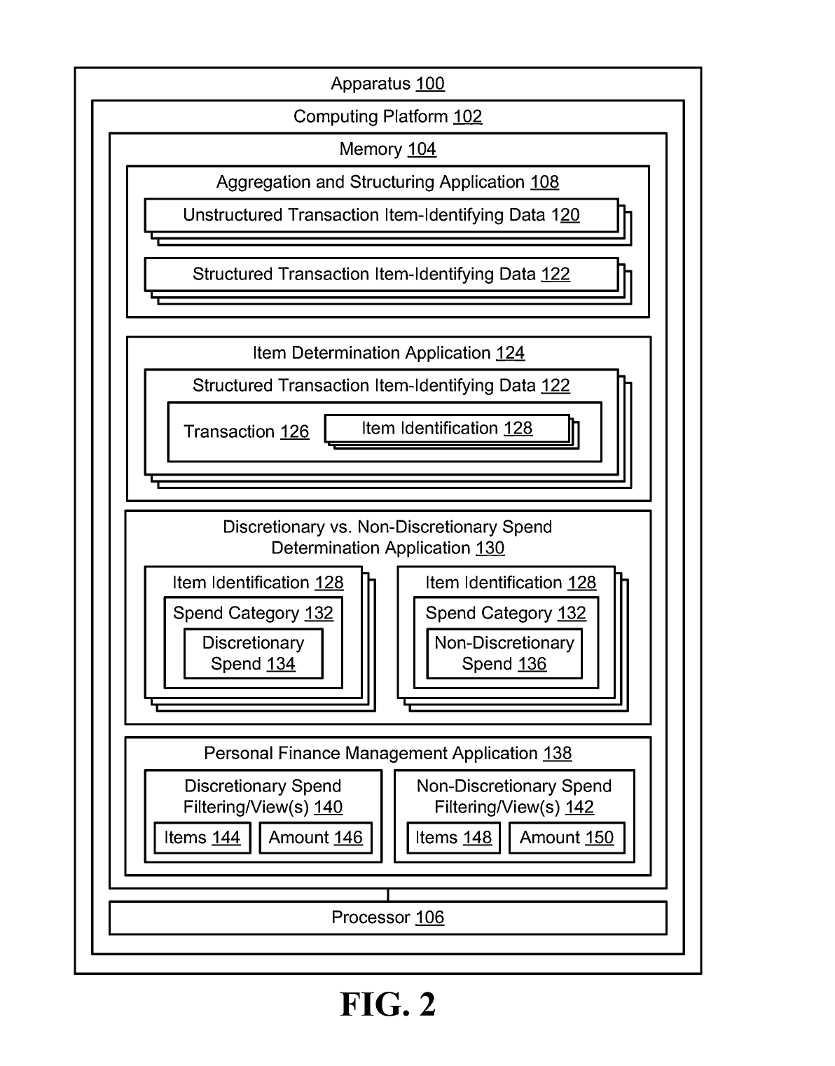

FIG. 2 provides a block diagram of an apparatus 100 configured for determining discretionary and non-discretionary spend of items identified in transactions and providing related discretionary and non-discretionary filtering in personal finance management applications, in accordance with embodiments of the present invention. The apparatus includes a computing platform 102 having a memory 104 and at least one processor 106 that is communication with the memory 104. The memory 104 of apparatus 100 stores aggregation and structuring application 108 that is executable by processor 106 and configured to receive unstructured transaction identifying-data 120, such as e-receipts, purchase confirmations, shipping confirmations, scanned receipts and the like, associated with transactions conducted by a customer, and process the data to result in structured transaction item-identifying data 122. The process of such data is described in detail in relation to FIG. 1 and may include crawling email accounts to collect e-receipts and the like from a customer's email account, parsing the transaction item-identifying data using predetermined templates to render item-identifying data and other relevant data from the e-receipts and the like, and formatting the data in a format accessible to financial institution systems, such as personal finance management systems (e.g., online banking, mobile banking and the like).

The memory 104 of apparatus 100 additionally includes item determination application 124 that is executable by the processor 106 and configured to determine, from the structured transaction item-identifying data 122, the item identification 128 of the one or more items in the transaction 126. The item identification 128 may be a Stock Keeping Unit (SKU), Uniform Product Code (UPC) or the like that is configured to provide identifying information related to the item, such as product name, product category or the like. As such, item determination application 124 may be configured to access, on a regularly scheduled basis or on-demand, the database that stores the structured transaction item-identifying data 122 to capture the data that identifies items in the transaction.

In addition, the memory 104 of apparatus 100 stored discretionary and non-discretionary spend determination application 130 that is executable by processor 106 and configured to determine a spend category 132 for each of the items in the transaction 126 based on the item identification 128 and predetermined spend categories 132. The predetermined spend categories 132 may include, but are not limited to, clothing, groceries, household items, personal care items, entertainment, restaurants, lodging, personal services, and the like. In specific embodiments spend categories 132 may be further divided into spend sub-categories (not shown in FIG. 2), for example, groceries may have sub-categories for staple groceries (e.g., milk, eggs, meat, produce, fruits and the like) and non-staple groceries (e.g., snacks, candy, sodas and the like). Spend categories 132 and sub-categories may be defined by the application 130 and/or the application 130 may be configured to allow the user/customer to define or modify the spend categories 132 and/or sub-categories. Further, the discretionary and non-discretionary spend determination application 130 is configured to determine whether each of the items is a discretionary spend 134 or a non-discretionary spend 136 based on predetermined discretionary and non-discretionary designations assigned to the spend categories 132 and the spend sub-categories. The discretionary and non-discretionary designations assigned to the spend categories or spend sub-categories may be defined by the application 130 and/or the application 130 may be configured to allow the user/customer to define or modify the discretionary and non-discretionary designations assigned to the spend categories 132 and/or sub-categories. In instances in which the user/customer defines or modifies the discretionary and non-discretionary designations such designations may occur dynamically, on-the-fly, so as to change the designation for items purchased in a recent transaction.

Moreover, in alternate embodiments of the invention, the discretionary and non-discretionary spend determination application 130 may be configured to determine whether each of the items is a discretionary spend 134 or a non-discretionary spend 136 based on the item identification 128 and a predetermined discretionary or non-discretionary designation assigned to the item identification 128. Thus, in such embodiments, the need to determine a spend category 132 is deemed unnecessary for the purpose of determining discretionary and non-discretionary spend 134 and 136.

The memory 104 of apparatus 100 additionally includes personal finance management (PFM) application 138, such as on online banking application, mobile banking application or the like, which is executable by the processor 106 and configured to match the transactions 126 associated with the structured transaction item-identifying data 122 with transactions indicated in the application 138 and provide discretionary spend filtering 140 and non-discretionary spend filtering for items 144, 148 in the transactions. The filtering 138, 140 is configured to provide views of which items 144, 148, and a corresponding purchase amount 146, 150, are categorized as discretionary spend 134 and non-discretionary spend 136.

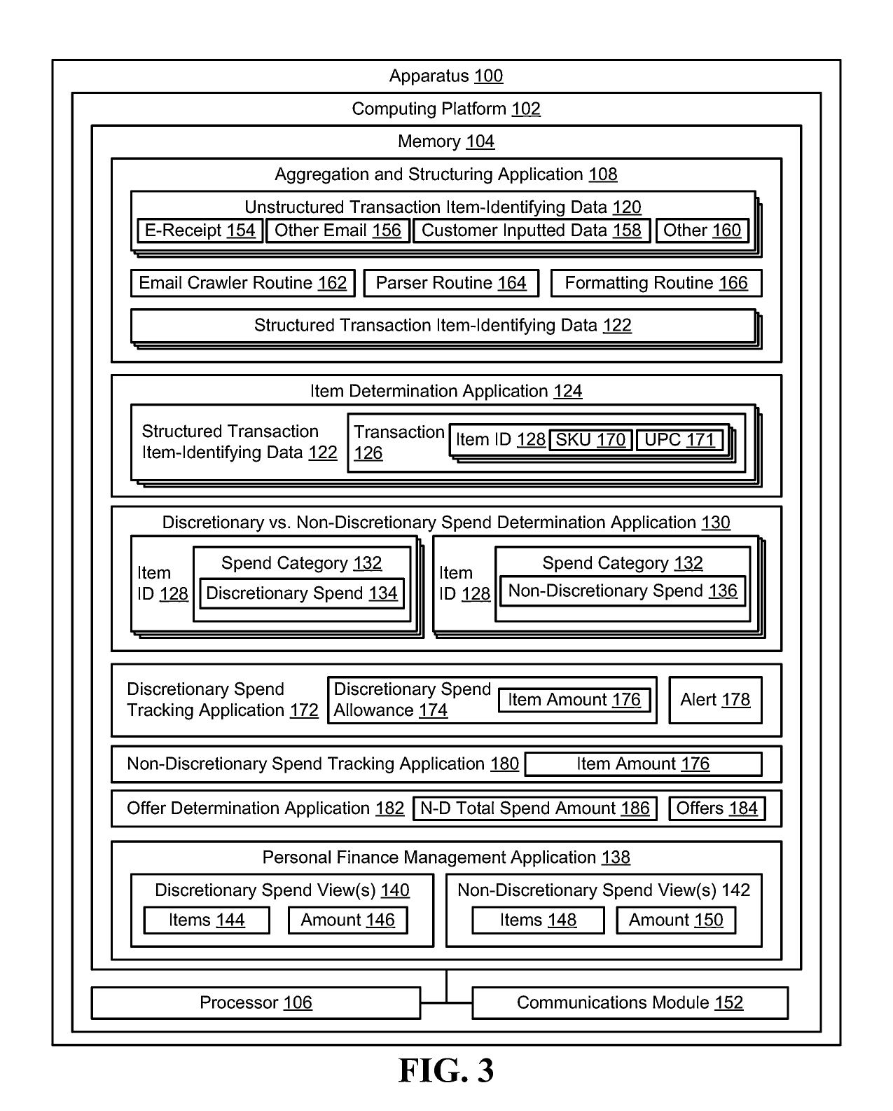

Referring to FIG. 3 shown is a more detailed block diagram of apparatus 100, according to embodiments of the present invention. As previously described, the apparatus 100 is configured to determine discretionary and non-discretionary spend of items identified in transactions and providing related discretionary and non-discretionary filtering in personal finance management applications. In addition to providing greater detail, FIG. 3 highlights various alternate embodiments of the invention. The apparatus 100 may include one or more of any type of computerized device. The present apparatus and methods can accordingly be performed on any form or combination of computing devices, including servers, personal computing devices, laptop/portable computing devices, mobile computing devices or the like.

The apparatus 100 includes computing platform 102 that can receive and execute routines and applications. Computing platform 102 includes memory 104, which may comprise volatile and non-volatile memory, such as read-only and/or random-access memory (RAM and ROM), EPROM, EEPROM, flash cards, or any memory common to computer platforms. Further, memory 104 may include one or more flash memory cells, or may be any secondary or tertiary storage device, such as magnetic media, optical media, tape, or soft or hard disk.

Further, computing platform 102 also includes processor 106, which may be an application-specific integrated circuit (“ASIC”), or other chipset, processor, logic circuit, or other data processing device. Processor 106 or other processor such as ASIC may execute an application programming interface (“API”) (not shown in FIG. 3) that interfaces with any resident programs, such as aggregation and structuring application 108, item determination application 124, discretionary vs. non-discretionary spend determination application 130, discretionary and non-discretionary tracking applications 172 and 180, offer determination application 182 and personal finance management application 138 or the like stored in the memory 104 of the apparatus 100.

Processor 106 may include various processing subsystems (not shown in FIG. 3) embodied in hardware, firmware, software, and combinations thereof, that enable the functionality of apparatus 100 and the operability of the apparatus on a network. For example, processing subsystems allow for initiating and maintaining communications and exchanging data with other networked devices. For the disclosed aspects, processing subsystems of processor 106 may include any subsystem used in conjunction with aggregation and structuring application 108, item determination application 124, discretionary vs. non-discretionary spend determination application 130, discretionary and non-discretionary tracking applications 172 and 180, offer determination application 182 and personal finance management application 138 or subcomponents or sub-modules thereof.

Computer platform 102 additionally includes communications module 152 embodied in hardware, firmware, software, and combinations thereof, that enables communications among the various components of the apparatus 100, as well as between the other devices in the transaction system, the aggregation and structuring system and/or the financial institution system. Thus, communication module 152 may include the requisite hardware, firmware, software and/or combinations thereof for establishing a network communication connection and initiating communication amongst networked devices.

As previously noted, the memory 104 of computing platform 102 stores aggregation and structuring application 108 that is executable by processor 106 and configured to receive unstructured transaction identifying-data 120, such as e-receipts 154, (e.g., purchase confirmations, shipping confirmations), other relevant emails 156, customer inputted data 158 (e.g., scanned hard-copy receipts or manually inputted hard copy receipt data) and any other data indicating a transaction conducted by the customer and the items included in the transaction 160, and process the data to result in structured transaction item-identifying data 122. In specific embodiments of the invention, the aggregation and structuring application 108 includes email crawler routine 162 that is configured to crawl email accounts(s) of the customer to identify and collect emails containing transaction data. Details of the email crawler routine 162 are discussed in relation to FIG. 1. The emails that are collected, which are herein collectively referred to as e-receipts, may include, but are not limited to, purchase confirmations, shipping confirmations, and any other emails including indicating a transaction and/or the items included in the transaction.

The aggregation and structuring application 108 may additionally include parser routine 164 that is configured to implement predetermined templates to parse relevant data from the unstructured transaction item-identifying data 120. As discussed in detail in relation to FIG. 1, the predetermined templates may be configured to parse data such as, but not limited to, merchant name, merchant contact information, transaction location (i.e., physical location or online), item identifiers, such as SKUs, UPCs or the like, item names, item amount, total purchase amount, tax amount, data and time or transaction, shipping information and the like.

The aggregation and structuring application 108 may additionally include formatting routine 166 that is configured to format the parsed data into a format that is compatible and/or accessible to financial institutions. For example, in specific embodiments, the parsed data may be formatted to conform to Open Financial Exchange “OFX” specifications for the electronic exchange of financial data between financial institutions, businesses and customers via the Internet. Once parsed and formatted, the structured transaction item-identifying data 122 may be stored in a requisite database (not shown in FIG. 3) for subsequent access by the financial institution or other entities authorized by the customer to have access to such transaction item-identifying data.

As previously discussed in relation to FIG. 2, the memory 104 of apparatus 100 additionally includes item determination application 124 that is executable by the processor 106 and configured to determine, from the structured transaction item-identifying data 122, the item identification 128 of the one or more items in the transaction 126. The item identification 128 may be a Stock Keeping Unit (SKU) 170, Uniform Product Code (UPC) 171 or the like that is configured to provide identifying information related to the item, such as product name, product category or the like. As such, item determination application 124 may be configured to access, on a regularly scheduled basis or on-demand, the database that stores the structured transaction item-identifying data 122 to capture the data that identifies items in the transaction.

In addition, the memory 104 of apparatus 100 stores discretionary and non-discretionary spend determination application 130 that is executable by processor 106 and configured to determine a spend category 132 for each of the items in the transaction 126 based on the item identification 128 and predetermined spend categories 132. Further, the discretionary and non-discretionary spend determination application 130 is configured to determine whether each of the items is a discretionary spend 134 or a non-discretionary spend 136 based on predetermined discretionary and non-discretionary designations assigned to the spend categories 132. The spend categories 132 and the discretionary and non-discretionary designations assigned to the spend categories may be defined by the application 130 and/or the application 130 may be configured to allow the user/customer to define or modify the discretionary and non-discretionary designations assigned to the spend categories 132. As previously noted, in alternate embodiments of the invention, the discretionary and non-discretionary spend determination application 130 may be configured to determine whether each of the items is a discretionary spend 134 or a non-discretionary spend 136 based on the item identification 128 and a predetermined discretionary or non-discretionary designation assigned to the item identification 128. Thus, in such embodiments, the need to determine a spend category 132 is deemed obviated for the purpose of determining discretionary and non-discretionary spend 134 and 136.

In optional embodiments of the invention, the memory 104 of apparatus 100 stores discretionary spend tracking application 172 that is executable by the processor 106 and is configured to, in response to determining that that an item in a transaction is a discretionary spend, apply the purchase amount 176 of the item to a predetermined discretionary spend allowance 174. The discretionary spend allowance 174, which may be defined by the customer or determined based on inputs from the customer, customer spending habits, customer income, demographics data or the like, is the allotted amount for discretionary spending for a stated period of time, such as a year, a month, a week a day or the like. In addition, the discretionary spend allowance 174 may be for a specific spend category, such as entertainment expenditures, non-staple/non-essential groceries or the like. Moreover, the discretionary spend tracking application 172 may be configured to generate and initiate communication of an alert 178 to the customer in the event that the customer is close to, at or exceeding the discretionary spend allowance 174. In addition, other actions, such as self-imposed penalties or the like, may be taken in the event the customer is approaching or has exceeded the discretionary spend allowance 174.

In other optional embodiments of the invention, the memory 104 of apparatus 100 stores non-discretionary spend tracking application 172 that is executable by the processor 106 and is configured to, in response to determining that that an item in a transaction is a non-discretionary spend, apply the purchase amount 176 to an overall non-discretionary spend total for a predetermined period and/or overall non-discretionary spend total for a given spend category for a predetermined time period. For example, the year-to-date total spent for automobile fuel, the past twelve months/year of grocery expenditures or the like. In such embodiments of the invention, the personal finance management application 138 may be further configured to present the overall non-discretionary spend total and totals for spend categories to the customer along with comparison data, such as the customer's overall non-discretionary spend totals for previous like time periods (e.g., prior year year-to-date spent for automobile fuel, previous twenty-four to thirteen months of grocery expenditures or the like). In addition to self-comparison to previous like time periods, comparison data can be presented based on demographic data, non-discretionary spend total averages for similarly incomed or similarly geographically located individuals for the predetermined time period (i.e., current predetermined time period and/or previous predetermined time periods). Such comparison data may be instrumental to the customer in gauging current non-discretionary spending compared to previous non-discretionary spending and how the customer compares to similarly situated individuals in terms of non-discretionary spending.

In related optional embodiments of the invention, the memory 104 of apparatus 100 stores offer determination application 182 that is executable by the processor 106 and configured to determine one or more offers 184 for the customer based on the tracked overall discretionary and/or non-discretional spend amount 186 or the tracked discretionary and/or non-discretional spend amount for a spend category. For example, if the tracked non-discretional spend amount for automobile fuel indicates that the customer exceeds demographic average or is greatly in excess of the customer's previous spend amounts for automobile fuel, the offer determination application 184 may determine that an offer for a more fuel-efficient vehicle is appropriate or an offer for consideration of public transportation is necessary. Likewise, if the tracked non-discretional spend amount for home heating and cooling indicates that the customer exceeds demographic average or is greatly in excess of the customer's previous spend amounts for home heating and cooling, the offer determination application 184 may determine that an offer for home insulation, a high-tech thermostat or the like is appropriate. Offers may be generated and sent to the customer via the customer's chosen communication channel, such as text message, email message, social media posting, personal finance management application postings, conventional mail or the like.

Additionally, as previously discussed in relation to FIG. 2, the memory 104 of apparatus 100 additionally includes personal finance management (PFM) application 138, such as on online banking application, mobile banking application or the like, which is executable by the processor 106 and configured to match the transactions 126 associated with the structured transaction item-identifying data 122 with transactions indicated in the application 138 and provide discretionary spend filtering 140 and non-discretionary spend filtering for items 144, 148 in the transactions. The filtering 138, 140 is configured to provide views of which items 144, 148, and a corresponding purchase amount 146, 150, are categorized as discretionary spend 134 and non-discretionary spend 136.

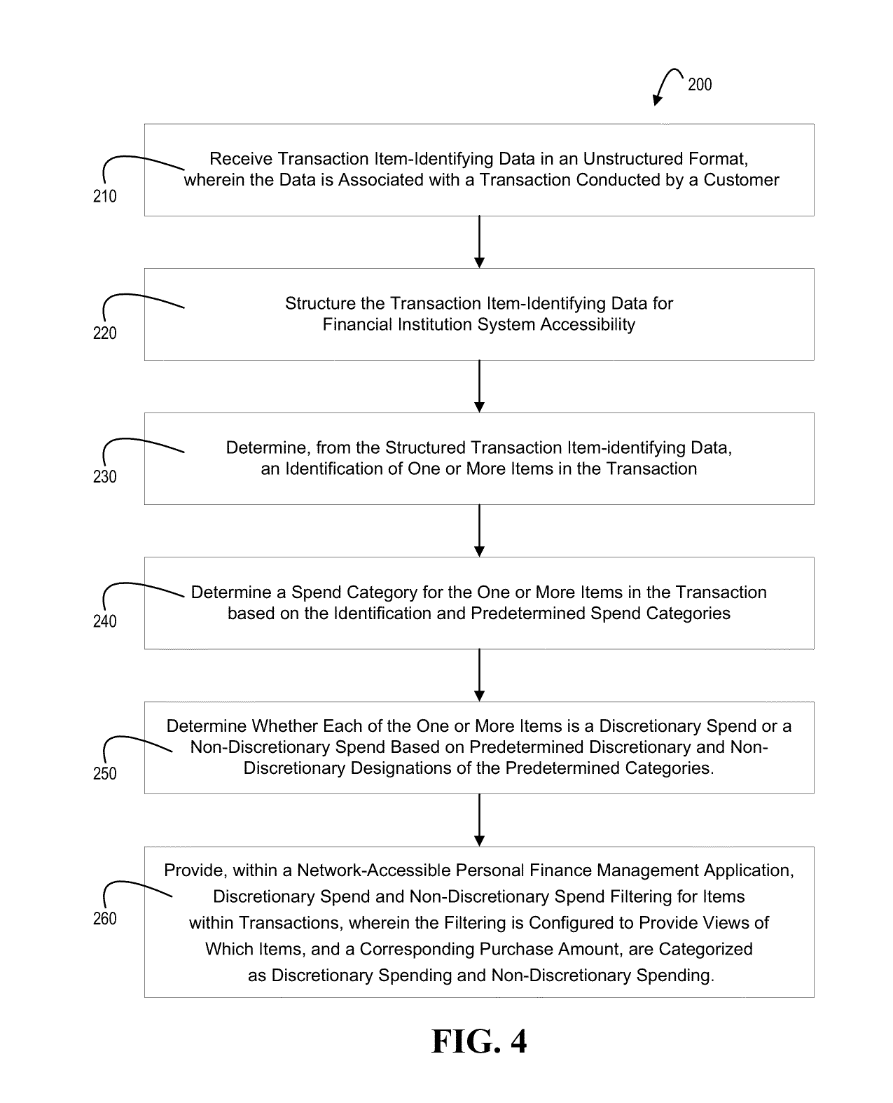

Referring to FIG. 4, a flow diagram of a method 200 for determining discretionary and non-discretionary spend of items identified in transactions and providing related discretionary and non-discretionary filtering in personal finance management applications, in accordance with embodiments of the present invention. At Event 210, transaction item-identifying data is received in an unstructured format. The transaction item-identifying data is associated with a transaction conducted by the customer and may include e-receipts (e.g., purchase conformation emails, shipping confirmation emails or the like), data from receipts scanned by the customer/user or manually inputted by the user/customer or data otherwise received or harvested form a merchant or customer. In specific embodiments of the invention, the transaction item-identifying data is received by crawling one or more email accounts associated with the customer to identify emails received that include the transaction item-identifying data (i.e., purchase confirmation emails, shipping confirmation emails or the like).

At Event 220, the unstructured transaction item-identifying data is structured for financial institution system capability. Structuring of the data may include applying a predetermined template to the data to parse or otherwise identify data that has been identified as relevant. The template(s) that is/are chosen to be applied to the data may be based on the form of the transaction item-identifying data, i.e., certain templates may apply to e-receipts, other templates may apply to customer inputted or scanned data. In addition to parsing data from the unstructured transaction item-identifying data, structuring the data may include reformatting the data to a format compatible with financial institution processing. For example, in specific embodiments, the data may be reformatted to conform to Open Financial Exchange “OFX” specifications for the electronic exchange of financial data between financial institutions, businesses and customers via the Internet. Once parsed and reformatted the structured data may be stored in associated database.

At Event 230, item identification is determined for the items in the transaction from the structured transaction item-identifying data. The item identification 128 may be a Stock Keeping Unit (SKU), Uniform Product Code (UPC) or the like that is configured to provide identifying information related to the item, such as product name, product category or the like. In specific embodiments, the determination of the item identification may provide for accessing, on a regularly scheduled basis or on-demand, the database that stores the structured transaction item-identifying data 122 to identify and capture the data that identifies items in the transaction.

At Event 240, a spend category is determined for each of the items in the transaction based on the item identification and predetermined spend categories. The spend categories may be preconfigured by the financial institution and/or modified or defined by the customer. In addition, as previously discussed, each category may have sub-categories so as to able to further distinguish items within a category.

At Event 250, discretionary or non-discretionary spend is determined for each of items in the transaction based on predetermined discretionary and non-discretionary designations assigned to the spend categories. The discretionary and non-discretionary designations assigned to the spend categories may be recommended/pre-configured by the financial institution and/or the customer may modify or define the discretionary and non-discretionary designations assigned to the spend categories. As previously noted, in alternate embodiments of the invention, the determination of the discretionary and non-discretionary spend may occur based on the item identification and a predetermined discretionary or non-discretionary designation assigned to the item identification. Thus, in such embodiments, the need to determine a spend category is deemed obviated for the purpose of determining discretionary and non-discretionary spend.

At Event 260, discretionary spend and non-discretionary spend filtering for items within the transactions is provided within network-accessible personal finance management application(s), such as online banking, mobile banking and the like. The filtering is configured to provided views of which items, and a corresponding purchase amount, are categorized as discretionary spend and which are categorized as non-discretionary spend. Other relevant information such as merchant, transaction date and the like may also be presented in the views and be configured to be sortable data (e.g., sortable by earliest/latest transaction data, alphabetical as to merchant or item, highest/lowest purchase amount and the like).

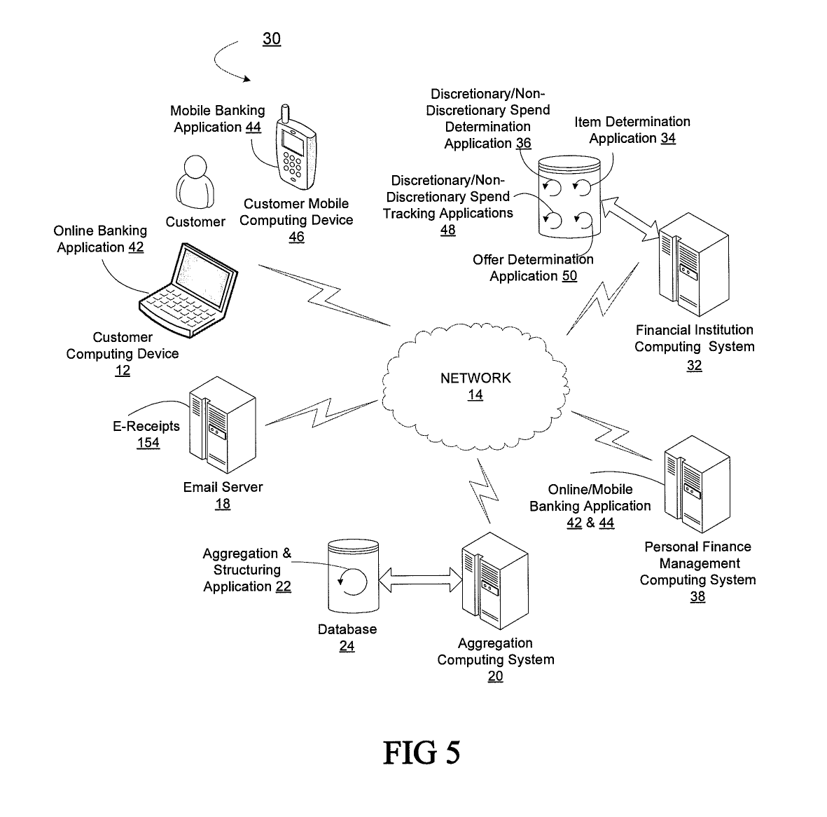

Referring to FIG. 5 a schematic diagram 30 is provided of a computing network environment for implementing embodiments of the present invention. The network 14 which serves as the communication hub may comprise any combination of one or more of the Internet, a wide area network, a local area network, a short range/near field network or any other form of contact or contactless network. The aggregation computing system 20 receives transaction item-identifying data in an unstructured format. The transaction item-identifying data is associated with a transaction conducted by the customer. In specific embodiments, the transaction item-identifying data are emails, such as e-receipts 154 obtained from crawling email accounts stored on email server 18. The aggregation computing system includes database 24 which stores aggregation and structuring application 22, which is configured to structure the unstructured transaction item-identifying data for financial institution compatibility. Structuring of the data may include parsing the unstructured data using predetermined templates and/or formatting the data to a format compatible with financial institution standards for communication and presentation. Once the data has been properly structured the data may be stored in database 24 or another database located on network 14.

Financial institution computing system 32 is in communication with database 24 and stores item determination application 34 and discretionary and non-discretionary spend determination application 36. Item determination application 34 is configured to determine or otherwise identify, from the structured transaction item-identifying data, item identification for the items in the transactions. The item identification may be a SKU, a UPC, or some other form of identifier (including language/words that identify the product). The item identification application 34 may be configured to access database 24 or some other database that stores the structured transaction item-identifying data to identify the objects in the database that identify the items in transactions.

Discretionary and non-discretionary spend determination application 36 is configured to determine a spend category for each item in the transaction based on the item identification and predetermined spend categories and, once the spend category is determined, identify the item as a discretionary or non-discretionary spend based on predetermined discretionary and non-discretionary designations assigned to the spend categories. In alternate embodiments, in which spend categories are not required to be determined, discretionary and non-discretionary spend may be determined based on the item identification and predetermined discretionary and non-discretionary designations assigned to the identified item.

Personal finance management computing system 38 which may include a portion or all of financial institution computing system 32 or may be a separate entity of the financial institution or of a third party is configured to execute personal finance management applications, such as online banking application 42 or mobile banking application 44. The personal finance management application is configured to provide discretionary spend and non-discretionary spend filtering for items within the transactions. The filtering is configured to present the customer, via customer computing device 12, which accesses online banking application 42 and customer mobile computing device 46, which accesses mobile banking application 44, with views of which items, and a corresponding purchase amount, are categorized as discretionary spend and non-discretionary spend.

In optional embodiments of the invention, financial institution computing system 32 may store discretionary and/or non-discretionary spend tracking applications 48 which are configured to apply the purchase amount of items to running totals of discretionary spend and non-discretionary and, in some embodiments, compare the current total to discretionary or non-discretionary spend allowances for a given period of time. Additionally, discretionary and/or non-discretionary spend tracking applications 48 may be configured to generate and initiate communication of customer alerts that configured to notify the customer as a spend allowance is approaching being met, is met or has been exceeded. In addition, discretionary and/or non-discretionary spend tracking applications 48 may be configured to provide comparative data, such as the customer's previous discretionary or non-discretionary spend totals for previous like period of time or demographic data showing like individuals (e.g., similar in income, location or the like) discretionary and/or non-discretionary spend totals for current periods of time or previous periods of time. Such comparative data may be presented to the customer through personal finance management computing system 38 or some other communication channel.

In still further optional embodiments of the invention, financial institution computing system 32 may store offer determination application 50 that is configured to determine offers for the customer based on the tracked totals of discretionary or non-discretionary spend for given spend categories. The offer determination application uses logic that determinates that the customer is spending more in a given category than they have previously or spending more than demographic averages and identifies offers that are geared toward the customer spending less in that particular spend category.

Thus, the present invention as described in detail above, provides for automatically determining discretionary and non-discretionary spending at a transaction item-level and providing related item-level filtering within a personal financial management application, such as online banking, mobile banking or the like. Such item-level filtering provides the customer with the detail necessary to ascertain the discretionary spend versus non-discretionary spend impact of items on an overall customer budget and to make necessary changes in future purchases so as to positively impact the customer's budget constraints.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for determining discretionary and non-discretionary spending and providing related filtering within a personal financial management application, the apparatus comprising:
a computing platform having a memory and at least one processor in communication with the memory device;
an aggregation and structuring application stored in the memory, executable by the processor and configured to receive transaction item-identifying data in an unstructured format, wherein the transaction item-identifying data is associated with a transaction conducted by a customer, structure the transaction item-identifying data for financial institution system accessibility and store the structured data in a first database;
an item determination application stored in the memory, executable by the processor and configured to determine, from the structured transaction item-identifying data, an identification of one or more items in the transaction;
a discretionary and non-discretionary spend determination application stored in the memory, executable by the processor and configured to determine a spend category for the one or more items in the transaction based on the identification and predetermined spend categories and determine whether each of the one or more items is a discretionary spend or a non-discretionary spend based on predetermined discretionary and non-discretionary designations of the predetermined spend categories; and
a personal finance management application, stored in the memory, executable by the processor and configured to provide discretionary spend and non-discretionary spend filtering for items within transactions, wherein the filtering is configured to provide views of which items and a corresponding purchase amount are categorized as discretionary spending and non-discretionary spending.

2. The apparatus of claim 1, wherein the aggregation and structuring application is further configured to receive an e-receipt corresponding to the transaction conducted by the identified customer, wherein the e-receipt includes one or more unique identifiers each of which identify the one or more items in the transaction.

3. The apparatus of claim 2, wherein the aggregation and structuring application is further configured to crawl an email account held by the identified customer to identify and collect e-receipts received by the identified customer.

4. The apparatus of claim 1, further comprising a discretionary spend tracking application stored in the memory, executable by the processor and configured to, in response to determining that an item is a discretionary spend, apply the purchase amount of the discretionary spend to a predetermined discretionary spend allowance.

5. The apparatus of claim 4, wherein the discretionary spend tracking application is further configured to generate and initiate communication of an alert that is configured to notify the customer that they are approaching or have exceeded the predetermined discretionary spend allowance.

6. The apparatus of claim 1, further comprising a non-discretionary spend tracking application stored in the memory, executable by the processor and configured to, in response to determining that an item is a non-discretionary spend, apply the purchase amount of the non-discretionary spend to a related category tracking amount.

7. The apparatus of claim 6, wherein the personal finance management application is further configured to provide one or more non-discretionary spend tracking views that provide for tracking amounts spent within a non-discretionary spend category.

8. The apparatus of claim 7, wherein the personal finance management application is further configured to provide the one or more non-discretionary spend tracking views that provide for comparing the tracked amounts spent within the non-discretionary spend category for a current period of time to, at least one of, an amount spent by the customer within the non-discretionary spend category for a previous same period of time or an average amount spent by a group of demographically-similar other customers during the current period of time or the previous period of time.

9. The apparatus of claim 1, further comprising an offer determination application stored in the memory, executable by the processor and configured to determine one or more offers to provide to the customer related to one or more items in a non-discretionary spend category, wherein the offers determined are based on a total amount spent within the non-discretionary spend category over a predetermined period of time.

10. A method for determining discretionary and non-discretionary spending and providing related filtering within a personal financial management application, the method comprising:
receiving, by a computing device processor, transaction item-identifying data in an unstructured format, wherein the transaction item-identifying data is associated with a transaction conducted by a customer;
structuring, by a computing device processor, the transaction item-identifying data for financial institution system accessibility;
determining, by a computing device processor, from the structured transaction item-identifying data, an identification of one or more items in the transaction;
determining, by a computing device processor, a spend category for the one or more items in the transaction based on the identification and predetermined spend categories;
determining, by a computing device processor, whether each of the one or more items is a discretionary spend or a non-discretionary spend based on predetermined discretionary and non-discretionary designations of the predetermined spend categories; and
providing, by a computing device processor, within a network-accessible personal finance management application, discretionary spend and non-discretionary spend filtering for items within transactions, wherein the filtering is configured to provide views of which items and a corresponding purchase amount are categorized as discretionary spending and non-discretionary spending.

11. The method of claim 10, wherein receiving the transaction item-identifying data further comprises receiving an e-receipt corresponding to the transaction conducted by the identified customer, wherein the e-receipt includes one or more unique identifiers each of which identify the one or more items in the transaction.

12. The method of claim 11, further comprising crawling, by a computing device processor, an email account held by the identified customer to identify and collect e-receipts received by the identified customer.

13. The method of claim 10, further comprising, in response to determining that an item is a discretionary spend, applying, by a computing device processor, the purchase amount of the discretionary spend to a predetermined discretionary spend allowance.

14. The method of claim 13, further comprising generating and initiating communication, by a computing device processor, of an alert that notifies the customer that they are approaching or have exceeded the predetermined discretionary spend allowance.

15. The method of claim 10, further comprising, in response to determining that an item is a non-discretionary spend, applying, by a computing device processor, the purchase amount of the non-discretionary spend to a related category tracking amount.

16. The method of claim 15 further comprising providing, by a computing device processor, within the network-accessible personal finance management application, one or more non-discretionary spend tracking views that provide for tracking amounts spent within a non-discretionary spend category.

17. The method of claim 16, wherein providing the one or more non-discretionary spend tracking views further comprises providing, by a computing device processor, within the network-accessible personal finance management application, the one or more non-discretionary spend tracking views that provide for comparing the tracked amounts spent within the non-discretionary spend category for a current period of time to, at least one of, an amount spent by the customer within the non-discretionary spend category for a previous same period of time or an average amount spent by a group of demographically-similar other customers during the current period of time or the previous period of time.

18. The method of claim 10, further comprising determining, by a computing device processor, one or more offers to provide to the customer related to one or more items in a non-discretionary spend category, wherein the offers determined are based on a total amount spent within the non-discretionary spend category over a predetermined period of time.

19. A computer program product comprising:
a non-transitory computer-readable medium comprising:
a first set of codes for causing a computer to receive, receiving transaction item-identifying data in an unstructured format, wherein the transaction item-identifying data is associated with a transaction conducted by a customer;
a second set of codes for causing a computer to structure the transaction item-identifying data for financial institution system accessibility;
a third set of codes for causing a computer to determine from the structured transaction item-identifying data, an identification of one or more items in the transaction;
a fourth set of codes for causing a computer to determine a spend category for the one or more items in the transaction based on the identification and predetermined spend categories;
a fifth set of codes for causing a computer to determine whether each of the one or more items is a discretionary spend or a non-discretionary spend based on predetermined discretionary and non-discretionary designations of the predetermined spend categories; and
a sixth set of codes for causing a computer to provide, within a network-accessible personal finance management application, discretionary spend and non-discretionary spend filtering for items within transactions, wherein the filtering is configured to provide views of which items and a corresponding purchase amount are categorized as discretionary spending and non-discretionary spending.

20. The computer program product of claim 19, wherein the first set of codes is further configured to receive an e-receipt corresponding to the transaction conducted by the identified customer, wherein the e-receipt includes one or more unique identifiers each of which identify the one or more items in the transaction.

21. The computer program product of claim 20, wherein the first set of codes is further configured to receive the email by crawling an email account held by the identified customer to identify and collect e-receipts received by the identified customer.

22. The computer program product of claim 19, further comprising a seventh set of codes for causing a computer to, in response to determining that an item is a discretionary spend, apply the purchase amount of the discretionary spend to a predetermined discretionary spend allowance.

23. The computer program product of claim 22, further comprising an eighth set of codes for causing a computer to generate and initiate communication of an alert that notifies the customer that they are approaching or have exceeded the predetermined discretionary spend allowance.

24. The computer program product of claim 19, further comprising a seventh set of codes for causing a computer to, in response to determining that an item is a non-discretionary spend, apply the purchase amount of the non-discretionary spend to a related category tracking amount.

25. The computer program product of claim 24 wherein the sixth set of codes is further configured to cause the computer to provide, within the network-accessible personal finance management application, one or more non-discretionary spend tracking views that provide for tracking amounts spent within a non-discretionary spend category.

26. The computer program product of claim 25, wherein the sixth set of codes is further configured to cause the computer to provide, within the network-accessible personal finance management application, the one or more non-discretionary spend tracking views that provide for comparing the tracked amounts spent within the non-discretionary spend category for a current period of time to, at least one of, an amount spent by the customer within the non-discretionary spend category for a previous same period of time or an average amount spent by a group of demographically-similar other customers during the current period of time or the previous period of time.

27. The computer program product of claim 19, further comprising a seventh set of codes for causing a computer to determine one or more offers to provide to the customer related to one or more items in a non-discretionary spend category, wherein the offers determined are based on a total amount spent within the non-discretionary spend category over a predetermined period of time.
